(19) United States
(12) Patent Application Publication
(10) Pub. No.: US 2020/0118118 A1
(43) Pub. Date: Apr. 16, 2020

(54) Method and Apparatus for Processing Digital Asset Based on Blockchain

(71) Applicant: DAEX Blockchain Group Limited, Ebene (MU)

(72) Inventors: Yan ZHOU, Ebene (MU); Ruicong TANG, Ebene (MU); Hua ZHANG, Ebene (MU)

(21) Appl. No.: 16/158,328

(22) Filed: Oct. 12, 2018

(51) Int. Cl. G06Q 20/36; G06Q 20/06; H04L 9/06

(52) U.S. Cl. CPC G06Q 20/3678; H04L 9/0637; G06Q 20/0658; G06Q 20/3676

(57) ABSTRACT

Provided are a method and apparatus for processing digital asset based on blockchain. The method comprises: acquiring target digital assets to be transferred into a primary account, wherein the primary account is an account created on the blockchain; and transferring the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account. By the present application, the problem in the related art that the operation is inconvenient due to the fact that the registration and trusteeship of target digital assets cannot be subjected to a cross-platform transaction is solved.

### TECHNICAL FIELD

The present application relates to the technical field of digital asset processing, and particularly to a method and apparatus for processing digital asset based on blockchain.

### BACKGROUND

With the continuous increase of market demands for the target digital assets such as bitcoin and with the continuous rise on bitcoin investment values, various target digital asset transaction platforms come up like mushrooms. The booming of the target digital asset transaction markets makes various altcoins come in flocks, wherein there is no lack of assets packaged by concept of blockchain. Nowadays, transaction platforms usually use technical means to provide service modules such as account system, KYC, asset recharge, asset trusteeship, matchmaking transaction, asset settlement, asset swap, and so on. However, target digital assets which are registered and trusted in various transaction platforms can only be transacted on their own platforms and cannot be subjected to a cross-platform transaction; and there is necessary to perform extraction, recharge, registration and trusteeship from the original platform to a next platform during the cross-platform transaction, thus not only the procedure is complicated, but also a high service fee is needed for asset extraction and registration each time. In addition, the transaction platform where in charge of storing actual assets of the transaction and providing a transaction service at the same time, it is more easier to generate supervision loopholes, and being incapable of guaranteeing the asset safety of the user.

Up to now, with regard to the problem in the related art that the operation is inconvenient due to the fact that the registration and trusteeship of target digital assets cannot be subjected to a cross-platform transaction, there is no any effective solution has been proposed yet.

### SUMMARY

A main objective of the present application is to provide a method and apparatus for processing digital asset based on blockchain, so as to solve the problem in the related art that the operation is inconvenient due to the fact that the registration and trusteeship of target digital assets cannot be subjected to a cross-platform transaction.

To achieve the foregoing objective, according to an aspect of the present application, a method for processing digital asset based on blockchain is provided. The method comprises: acquiring target digital assets to be transferred into a primary account, wherein the primary account is an account created on the blockchain; and transferring the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account.

Further, after transferring the target digital assets into the primary account, the method further comprises: transferring, by a first position in the blockchain, a first digital asset in the target digital assets from the primary account into a first sub-account, so that a first resource transfer event is performed by using the first digital asset in a first digital asset transfer object linked by the first sub-account, wherein the first sub-account is one of the multiple sub-accounts.

Further, after transferring the target digital assets into the primary account, the method further comprises: transferring a first digital asset in the target digital assets from the primary account into a first sub-account through a first position in the blockchain, so that a first resource transfer event is performed by using the first digital asset in a first digital asset transfer object linked by the first sub-account, wherein the first sub-account is an account in the first digital asset transfer object linked by one of the multiple sub-accounts, and the first digital asset is configured to be transferred into the first sub-account during or after performing the first resource transfer event.

Further, after transferring a first digital asset in the target digital assets from the primary account into a first sub-account in the multiple sub-accounts, the method further comprises: synchronizing the transfer information to positions other than the first position in the blockchain through the first position, so that the transfer information is recorded at positions other than the first position in the blockchain, wherein the transfer information at least comprises: the primary account and the first sub-account with the corresponding relationship, the remaining digital assets of the primary account after transferring the first digital asset out, and the digital assets of the first sub-account after transferring the first digital asset in.

Further, transferring a first digital asset in the target digital assets from the primary account into a first sub-account comprises through a first position in the blockchain: acquiring a smart contract of the primary account and a smart contract of the first sub-account; and transferring the first digital asset in the target digital assets from the primary account to the first sub-account according to the smart contract of the primary account and the smart contract of the first sub-account.

Further, before transferring the target digital assets into the primary account, the method further comprises: acquiring a transfer request for requesting to transfer the target digital assets, wherein the transfer request carries information about the target digital assets to be transferred and information about the primary account into which the target digital assets are to be transferred; and acquiring the target digital assets to be transferred into the primary account comprises: acquiring the target digital assets to be transferred into the primary account when the information about the primary account satisfies a transfer condition.

Further, acquiring the transfer request for requesting to transfer the target digital assets comprises: acquiring the transfer request generated in response to a touch operation on a target application or a target webpage.

Further, transferring the target digital assets into the primary account comprises: transferring the target digital assets into a resource storage device; and establishing a mapping relationship between the primary account and the target digital assets, wherein the resource storage device is in an offline state after storing the target digital assets.

Further, the digital asset transfer object comprises: a target application or a target webpage.

Further, before acquiring target digital assets to be transferred into the primary account, the method further comprises: creating a primary account in the blockchain; calling a smart contract corresponding to a sub-account to be created under the primary account; and creating the multiple sub-accounts under the primary account on the basis of the smart contract corresponding to the sub-accounts to be created under the primary account.

Further, after transferring the target digital assets into the primary account, the method further comprises: when it is detected that the primary account is disabled at a first position in the blockchain, synchronizing disable information to positions other than the first position in the blockchain through the first position, so that the disabling information is recorded at positions other than the first position in the blockchain, wherein the disabling information comprises: disabling the primary account and multiple sub-accounts corresponding to the primary account.

To achieve the foregoing objective, according to another aspect of the present application, an apparatus for processing digital asset based on blockchain is provided. The apparatus comprises: an acquisition unit, configured to acquire target digital assets to be transferred into a primary account, wherein the primary account is an account created on the blockchain; and a transfer-in unit, configured to transfer the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account.

Further, a first transfer unit is configured to transfer, after transferring the target digital assets into the primary account, a first digital asset in the target digital assets from the primary account into a first sub-account by a first position in the blockchain, so that a first resource transfer event is performed by using the first digital asset in a first digital asset transfer object linked by the first sub-account, wherein the first sub-account is one of the multiple sub-accounts.

Further, the first transfer unit is configured to transfer, after transferring the target digital assets into the primary account, a first digital asset in the target digital assets from the primary account into a first sub-account by a first position in the blockchain, so that a first resource transfer event is performed by using the first digital asset in a first digital asset transfer object linked by the first sub-account, wherein the first sub-account is an account in the first digital asset transfer object linked by one of the multiple sub-accounts, and the first digital asset is configured to be transferred into the first sub-account during or after performing the first resource transfer event.

Further, a first synchronizing unit is configured to, after transferring a first digital asset in the target digital assets from the primary account into a first sub-account in the multiple sub-accounts, synchronize the transfer information to positions other than the first position in the blockchain through the first position, so that the transfer information is recorded at the positions other than the first position in the blockchain, wherein the transfer information at least comprises: the primary account and the first sub-account with the corresponding relationship, the remaining digital assets of the primary account after transferring the first digital asset out, and the digital assets of the first sub-account after transferring the first digital asset in.

Further, a first acquisition module is configured to acquire a smart contract of the primary account and a smart contract of the first sub-account; and a transfer module is configured to transfer the first digital asset in the target digital assets from the primary account to the first sub-account according to the smart contract of the primary account and the smart contract of the first sub-account.

To achieve the foregoing objective, according to another aspect of the present application, a storage medium is provided, wherein, the storage medium comprises a stored program, wherein the program executes the method for processing digital asset based on blockchain of any of the above.

To achieve the foregoing objective, according to another aspect of the present application, a processor is provided, wherein, the processor is configured to run a program, wherein the program is run to execute the method for processing digital asset based on blockchain of any of the above.

The present application adopts the following steps: acquiring target digital assets to be transferred into a primary account, wherein the primary account is an account created on the blockchain; and transferring the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account. Thereby, the problem in the related art that the operation is inconvenient due to the fact that the registration and trusteeship of target digital assets cannot be subjected to a cross-platform transaction is solved. By transferring target digital assets into the primary account, the transfer of digital assets in various sub-accounts of the primary account can achieve cross-platform transaction.

### BRIEF DESCRIPTION OF THE DRAWINGS

The drawings forming a part of the present application are used for providing a further understanding of the present application. The schematic embodiments and illustrations thereof of the present application are used for explaining the present application, and do not form improper limitations to the present application. In the drawings:

FIG. 1 shows a flowchart of a method for processing digital asset based on blockchain provided by an embodiment of the present application;

FIG. 2 shows a schematic diagram of an asset trusteeship request provided by an embodiment of the present application;

FIG. 3 shows a schematic diagram of an asset trusteeship address received by a user end provided by an embodiment of the present application;

FIG. 4 shows a flowchart of an alternative method for processing digital asset based on blockchain provided by an embodiment of the present application; and

FIG. 5 shows a schematic diagram of an apparatus for processing digital asset based on blockchain provided by an embodiment of the present application.

### DETAILED DESCRIPTION OF THE EMBODIMENTS

It should be noted that embodiments in the present application and characteristics in the embodiments may be combined with each other under the condition of no conflicts. Hereinafter, the present application will be illustrated in detail with reference to the drawings and in conjunction with the embodiments.

In order to enable those skilled in the art to better understand solutions of the present application, the technical solutions in embodiments of the present application will be clearly and completely described below in combination with drawings in embodiments of the present application. It is apparent that the described embodiments are only a part of the embodiments of the present application, not all of the embodiments. On the basis of the embodiments of the present application, all other embodiments obtained on the premise that no inventive effort is made for a person of ordinary skill in the art shall fall within the scope of protection of the present application.

It should be noted that the specification and claims of the present application and terms such as “first”, “second” and the like in the drawings mentioned above are used to distinguish similar objects, and do not need to describe a specific sequence or a precedence order. It will be appreciated that data used in such a way may be exchanged under appropriate conditions, so as to describe embodiments of the present application here. In addition, terms such as “comprise” and “have” and any variations thereof are intended to cover non-exclusive inclusions. For example, processes, methods, systems, products or devices containing a series of steps or units are not necessarily limited to those steps or units clearly listed, but can comprise other steps or units which are not clearly listed or are inherent to these processes, methods, products or devices.

### Embodiment 1

According to embodiments of the present invention, an embodiment of a method for processing digital asset based on blockchain is provided. The problem in the related art that the operation is inconvenient due to the fact that the registration and trusteeship of target digital assets cannot be subjected to a cross-platform transaction is solved by acquiring target digital assets to be transferred into a primary account, wherein the primary account is an account created on the blockchain and transferring the target digital assets into the primary account and at the same time the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account. The problem of inconvenience caused by that in related art the cross-platform transaction of the target digital asset registration and trusteeship cannot be performed is solved. The transfer of digital assets in various sub-accounts of the primary account may achieve the cross-platform transaction by transferring target digital assets into the primary account.

It should be noted that the steps shown in the flowchart of the drawings may be executed in a computer system comprising, for example, a set of computer-executable instructions. Moreover, although a logic sequence is shown in the flowchart, the shown or described steps may be executed in a sequence different from the sequence here under certain conditions.

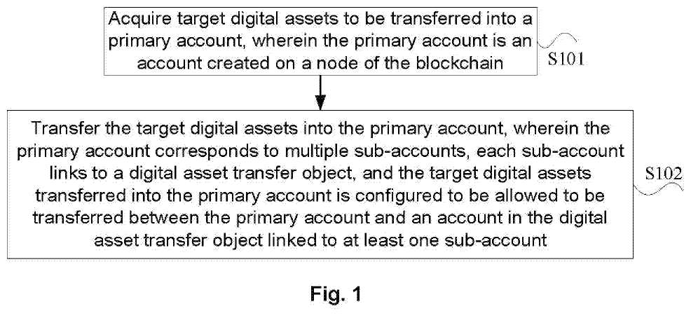

Specifically, the present invention provides a method for processing digital asset based on blockchain as shown in FIG. 1. FIG. 1 is a flowchart of a method for processing digital asset based on blockchain according to an embodiment of the present application. The method comprises the following steps:

Step S101: acquire target digital assets to be transferred into a primary account, wherein the primary account is an account created on the blockchain.

The target digital assets mentioned above are digital assets requested to be transferred after a user triggers a digital asset transfer request. The digital assets in the present invention may be digital assets such as bitcoin.

In some embodiments, in the method for processing digital asset which based, on blockchain provided by embodiments of the present application, after transferring the target digital assets into the primary account, the method further comprises: transfer the first digital asset in the target digital assets from the primary account into a first sub-account through the first position in the blockchain, so that a first resource transfer event is performed by using the first digital asset in a first digital asset transfer object linked by the first sub-account, wherein the first sub-account is one of the multiple sub-accounts.

By means of the solution mentioned above, after part of digital assets in the target digital assets are transferred from the primary account, into sub-accounts transaction may be performed through digital assets in the sub-accounts.

It should be noted that the first position mentioned above is a position where the primary account is created in the blockchain.

In some embodiments, in the method for processing digital asset based on blockchain provided by embodiments of the present application, after transferring the target digital assets into the primary account, the method further comprises: transfer the first digital asset in the target digital assets from the primary account into a first sub-account through the first position in the blockchain, so that a first resource transfer event is performed by using the first digital asset in a first digital asset transfer object linked by the first sub-account, wherein the first sub-account is an account in the first digital asset transfer object linked by one of the multiple sub-accounts, and the first digital asset is configured to be transferred into the first sub-account during or after performing the first resource transfer event.

By means of the solution mentioned above, part of digital assets in the target digital assets are transferred from the primary account to an account in a digital asset transfer object linked by sub-accounts thereof, and after part of digital assets in the target digital assets transferring into the account in the digital asset transfer object linked by the sub-accounts, transaction between the primary account and the account in the digital asset transfer object may be realized.

In some embodiments, in the method for processing digital asset based on blockchain provided by embodiments of the present application, after transferring a first digital asset in the target digital assets from the primary account to a first sub-account in the multiple sub-accounts, the method further comprises: synchronizing the transfer information to positions other than the first position in the blockchain through the first position, so that the transfer information is recorded at positions other than the first position in the blockchain, wherein the transfer information at least comprises: the primary account with corresponding relationship, first sub-account, the remaining digital assets of the primary account after transferring the first, digital asset out, and the digital assets of the first, sub-account after transferring the first digital asset in.

After the first digital asset in the target digital assets is transferred from the primary account to the first sub-account in the multiple sub-accounts, in order to ensure that all positions in the blockchain record this event, the transfer information is synchronized, synchronizing the transfer information to positions other than the first position in the blockchain through the first position. That is, through broadcasting the transfer information, all positions in the blockchain is informed of recoding this event. For example, the transfer information is the primary account and be transferred into the first sub-account of the digital asset, the remaining digital assets of the primary account after transferring the digital asset out, and the digital assets of the first sub-account after transferring the digital asset into the first sub-account.

Step S102, transfer the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked by at least one sub-account.

It should be noted that transferring the target digital assets into the primary account in embodiments of the present application refers to mapping digital assets that transferred by a user into the primary account, wherein the primary account corresponds to multiple sub-accounts. For example, a primary account A comprises a1, a2, a3, and a4 therein, wherein the sub-account a1 may link to a digital asset transfer object and is used for performing transaction in the digital asset transfer object.

In some embodiments, in the method for processing digital asset based on blockchain provided by embodiments of the present application, the digital asset transfer object comprises: a target application or a target webpage.

For example, the digital asset transfer object is a target application, that is a target application linked by a sub-account, capable of transferring digital assets between the primary account and the target application; the digital asset transfer object is a target webpage, that is a target webpage linked by a sub-account, that can be transferring digital assets between the primary account and the target webpage.

In some embodiments, in the method for processing digital asset based on blockchain provided by embodiments of the present application, transferring the first digital asset in the target digital assets from the primary account into a first sub-account through a first position in the blockchain comprises: acquiring a smart contract of the primary account and a smart contract of the first sub-account; and transferring the first digital asset in the target digital assets from the primary account to the first sub-account according to the smart contract of the primary account and the smart contract of the first sub-account.

By means of the solution mentioned above, the transfer is according to smart contract rules of accounts when transferring the digital assets from the primary account into the sub-account art, thereby ensuring the safety of digital asset transfer.

In some embodiments, in the method for processing digital asset based on blockchain provided by embodiments of the present application, transferring the target digital assets into the primary account comprises: transferring the target digital assets into a resource storage device; and establishing a mapping relationship between the primary account and the target digital assets, wherein the resource storage device is in an offline state after storing the target digital assets.

In order to ensure the safety of digital assets, target digital assets are transferred into a resource storage device; the resource storage device mentioned above may be a cold wallet and so on, configured to be in an offline state after transferring the target digital assets into the resource storage device for multiple times, thereby ensuring the safety of digital assets.

In some embodiments, in the method for processing digital asset based on blockchain provided by embodiments of the present application, before transferring the target digital assets into the primary account, the method further comprises: acquiring a transfer request for requesting to transfer the target digital assets, wherein the transfer request carries information about the target digital assets to be transferred and information about the primary account into which the target digital assets are to be transferred; and acquiring the target digital assets to be transferred into the primary account comprises: acquiring the target digital assets to be transferred into the primary account when the information about the primary account meets the transfer condition.

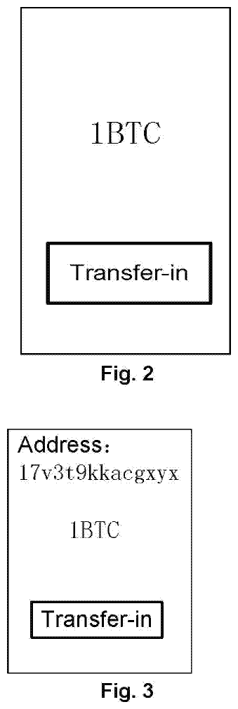

In embodiments of the present invention, for example, as shown in FIG. 2, when a user needs to transfer digital assets in, a user end will initiate an asset trusteeship request, and user identity information is retrieved by a third-party identity authentication platform: if the user information meet a preset condition, an asset registration request is initiated to an asset registration audit module; if the user information does not meet the preset condition, the asset trusteeship request of the user can not be passed, and the flow ends; and if the user information meet the preset condition, the asset trusteeship request of the user can be passed, and when an asset registration center receives the asset trusteeship request, an asset trusteeship address will be dynamically allocated and returned to the user end. As shown in FIG. 3, transferring the assets to be trusted to the trusteeship address after the user end receives the trusteeship address. A primary account of the user is created on the blockchain according to the identity information of the user and the identity ID thereof, and the assets of the user transferred to the trusteeship address are mapped into the primary account, that is, target digital assets to be transferred into the primary account are acquired.

In some embodiments, in the method for processing digital asset based on blockchain provided by embodiments of the present application, acquiring the transfer request for requesting to transfer the target digital assets comprises: acquiring the transfer request that generated in response to a touch operation on a target application or a target webpage.

A user end will perform a touch operation on a target application or a target webpage to initiate an asset trusteeship request when a user needs to transfer digital assets in, and so as to acquire a transfer request generated in response to the touch operation on the target application or the target webpage.

In some embodiments, in the method for processing digital asset based on blockchain provided by embodiments of the present application, before acquiring target digital assets that to be transferred into the primary account, the method further comprises: creating a primary account in the blockchain; calling a smart contract corresponding to a sub-account which was created under the primary account; and creating the multiple sub-accounts under the primary account on the basis of the smart contract corresponding to the sub-account which was created under the primary account.

By means of the solution mentioned above, the establishment is performed according to smart contract rules of sub-accounts when creating sub-accounts under the primary account,art. It should be noted that the relationship between the primary account of the mapped account and sub-accounts is an affiliation relationship, the sum of digital assets of the sub-accounts is equal to the digital assets of the primary account, and the sum of digital asset variations of the sub-accounts is equal to the digital asset variation of the primary account. The sub-accounts record transaction settlement records of the sub-accounts, and the primary account records all transaction settlement records.

In some embodiments, in the method for processing digital asset based on blockchain provided by embodiments of the present application, after transferring the target digital assets into the primary account, the method further comprises: when it is detected that the primary account is disabled at a first position in the blockchain, through the first position synchronizing the disable information to positions other than the first position in the blockchain, so that the disabling information is recorded at positions other than the first position in the blockchain, wherein the disabling information comprises: disabling the primary account and multiple sub-accounts corresponding to the primary account.

In some cases, it is necessary to disable the primary account at a position in the blockchain; when it is detected that the primary account is disabled at a first position in the blockchain, in order to ensure that all positions in the blockchain record this event, disabling information is synchronized to positions other than the first position in the blockchain through the first position. That is, by broadcasting the disabling information, all positions in the blockchain is informed of recoding this event. It should be noted that if a certain sub-account under the primary account is disabled, this event will also be broadcast in the blockchain to inform all positions, in order to record this event for all positions in the blockchain.

In the method for processing, digital asset based on blockchain provided by embodiments of the present application, through acquiring target digital assets to be transferred into a primary account, wherein the primary account is an account created on the blockchain; and transferring the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account. Thereby, the problem in the related art that the operation is inconvenient due to the fact that the registration and trusteeship of target digital assets cannot be subjected to a cross-platform transaction is solved. Through transferring target digital assets into the primary account, the transfer of digital assets in various sub-accounts of the primary account can achieve cross-platform transaction.

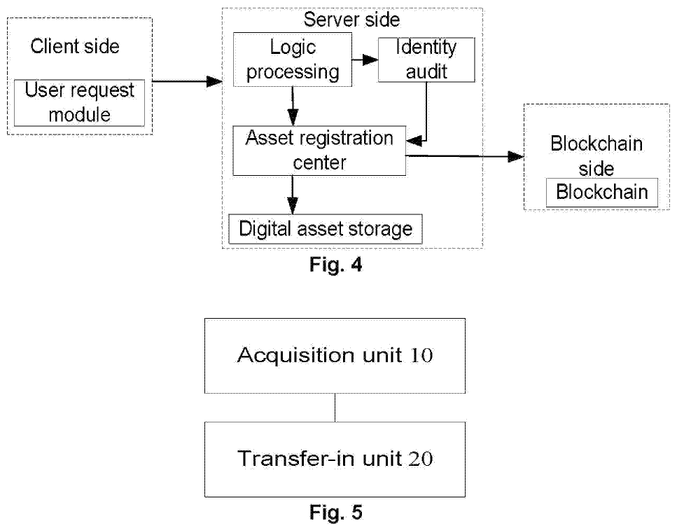

Hereinafter, the present application is described by taking digital assets as an example. As shown in FIG. 4, a user request access module is provided at a client side; a logic processing module, an identity audit module, an asset registration center module, and a digital asset storage module are set at a server side; and a blockchain module is set, at a blockchain side. The user request access module is in charge of accepting a user asset trusteeship request; the logic processing module receives a registration trusteeship application request that initiated by the client side to call the identity audit module and processes service logics; the identity audit module is in charge of the audit of the user identity by accessing a third-party identity authentication platform port; the digital asset storage module stores a blockchain digital asset that was registered and trusted by the user and then isolates the network; the asset registration center module is in charge of dynamically allocating a user trusteeship asset storage address, and auditing and monitoring billing situation of assets requesting to be registered; and the blockchain module receives a request initiated by the asset audit module and establishes a trusted account and an asset mapping account on the blockchain for the user, and maps the trusted asset of the user into the mapping account (corresponding to the primary account mentioned above). The user asset trusteeship request may be initiated through using a device-adapted APP or webpage by the user; the user needs to sign a smart contract with the asset registration center while initiating the request to complete operations that comprising identity authentication and transferring of the registered assets to a specified address; the third-party identity authentication platform may be an identity chain created by using an underlying blockchain technology, or may also be an identity authentication platform authenticated by a supervision department; the identity audit module only calls information contents specified by the contract in a smart contract manner; the trusted account and the asset mapping account are independent of each other, the trusted account is used for user asset settlement, and the asset mapping account is used for transaction and asset settlement; the trusted account and the asset mapping account are subordinate to the authenticated identity of the user; and the asset mapping account may establish sub-accounts that associated with each transaction platform under the name thereof, and sub-accounts may perform digital asset transaction with regard to each transaction platform. Thus, the problem in the related art where the operation is inconvenient due to the fact that the registration and trusteeship of target digital assets cannot be subjected to cross-platform transaction is solved.

It should be noted that mapping the trusted assets of the user into a mapping account refers to: by acquiring a result of synchronizing assets to an address, namely a situation of the billing of the trusted asset; recording the synchronization result into a smart contract, calling a mapping key to sign a mapping contract; and broadcasting the mapping contract, so that the contract achieves consensus across the whole network to complete mapping.

It should be noted that the steps shown in the flowchart of the drawings may be executed in a computer system comprising, for example, a set of computer-executable instructions. Moreover, although a logic sequence is shown in the flowchart, the shown or described steps may be executed in a sequence different from the sequence here under certain conditions.

The embodiments of the present application also provide An apparatus for processing digital asset based on blockchain. It should be noted that the blockchain-based digital asset processing apparatus in embodiments of the present application may be configured to execute the method for processing digital asset based on blockchain provided by embodiments of the present application. The blockchain-based digital asset processing apparatus provided by embodiments of the present application will be introduced below.

FIG. 5 is a schematic diagram of An apparatus for processing digital asset based on blockchain according to embodiments of the present application. As shown in FIG. 5, the device comprises: an acquisition unit 10 and a transfer-in unit 20.

The acquisition unit 10 is configured to acquire target digital assets to be transferred into a primary account, wherein the primary account is an account created on the blockchain; and

the transfer-in unit 20 is configured to transfer the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account.

In the blockchain-based digital asset processing apparatus provided by embodiments of the present application, obtain the target digital assets that to be transferred into a primary account by the acquisition unit 10, wherein the primary account is an account created on the blockchain; and the transfer-in unit 20 transfers the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked, to at least one sub-account. Thereby, the problem in the related art that the operation is inconvenient due to the fact that the registration and trusteeship of target digital assets cannot be subjected to a cross-platform transaction is solved. By transferring target digital assets into the primary account, the transfer of digital assets in various sub-accounts of the primary account can achieve cross-platform transaction.

In some embodiments, in the blockchain-based digital asset processing apparatus provided by embodiments of the present application, a first transfer unit is used for transfer the target digital assets into the primary account, then through a first position in the blockchain transfer the target digital assets from the primary account into a first sub-account, so that a first resource transfer event is, performed by using the first digital asset in a first digital asset transfer object linked by the first sub-account, wherein the first sub-account is one of the multiple sub-accounts.

In some embodiments, in the blockchain-based digital asset processing apparatus provided by embodiments of the present application, the first transfer unit is configured to transfer, after transferring the target digital assets into the primary account, a first digital asset in the target digital assets from the primary account into a first sub-account by a first position in the blockchain, so that a first resource transfer event is performed by using the first digital asset in a first digital asset transfer object linked by the first sub-account, wherein the first sub-account is an account in the first digital asset transfer object linked by one of the multiple sub-accounts, and the first digital asset is configured to be transferred into the first sub-account during or after performing the first resource transfer event.

In some embodiments, in the blockchain-based digital asset processing apparatus provided by embodiments of the present application, a first synchronizing unit is configured to, after transferring a first digital asset in the target digital assets from the primary account into a first sub-account in the multiple sub-accounts, synchronizing the transfer information to positions other than the first position in the blockchain through the first position, so that the transfer information is recorded at positions other than the first position in the blockchain, wherein the transfer information at least comprises: the primary account and the first sub-account with the corresponding relationship, the remaining digital assets of the primary account after transferring the first digital asset out, and the digital assets of the first sub-account after transferring the first digital asset in.

In some embodiments, in the blockchain-based digital asset processing apparatus provided by embodiments of the present application, a first acquisition module is configured to acquire a smart contract of the primary account and a smart contract of the first sub-account; and a transfer module is configured to transfer the first digital asset in the target digital assets from the primary account to the first sub-account according to the smart contract of the primary account and the smart contract of the first sub-account.

In some embodiments, in the blockchain-based digital asset processing apparatus provided by embodiments of the present application, a second acquisition module is configured to acquire a transfer request for requesting to transfer the target digital assets before transferring the target digital assets into the primary account, wherein the transfer request carries information about the target digital assets to be transferred and information about the primary account into which the target digital assets are to be transferred; and the acquisition unit is further configured to acquire the target digital assets to be transferred into the primary account when the information about the primary account meets a transfer-in condition.

In some embodiments, in the blockchain-based digital asset processing apparatus provided by embodiments of the present application, the second acquisition module is further configured to acquire the transfer request generated in response to a touch operation on a target application or a target webpage.

In some embodiments, in the blockchain-based digital asset processing apparatus provided by embodiments of the present application, the transfer-in unit is further configured to transfer the target digital assets into a resource storage device; and establish a mapping relationship between the primary account and the target digital assets, wherein the resource storage device is in an offline state after storing the target digital assets.

In some embodiments, in the blockchain-based digital asset processing apparatus provided by embodiments of the present application, the digital asset transfer object comprises: a target application or a target webpage.

In some embodiments, in the blockchain-based digital asset processing apparatus provided by embodiments of the present application, a first establishment unit is configured to establish, before acquiring target digital assets to be transferred into the primary account, the primary account in the blockchain; a calling unit is configured to call a smart contract corresponding to a sub-account to be created under the primary account; and a second establishment unit is configured to establish the multiple sub-accounts under the primary account according to the smart contract corresponding to the sub-accounts to be created under the primary account.

In some embodiments, in the blockchain-based digital asset processing apparatus provided by embodiments of the present application, a second synchronization unit is configured to, after transferring the target digital assets into the primary account, synchronizing the disable information to positions other than the first position in the blockchain when it is detected that the primary account is disabled at the first position in the blockchain through the first position, so that the disabling information is recorded at the positions other than the first position in the blockchain, wherein the disabling information comprises: disabling the primary account and multiple sub-accounts corresponding to the primary account.

The blockchain-based digital asset processing apparatus comprises a processor and a memory. The acquisition unit 10, the transfer-in unit 20 mentioned above are stored in the memory as program units, and the processor executes the program units mentioned above stored in the memory to achieve corresponding functions.

The processor comprises a kernel, which retrieves corresponding program units from the memory. There may be one or more kernels, and the cross-platform transaction of registration and trusteeship of the target digital assets is realized by adjusting kernel parameters.

The memory may comprise forms such as a non-permanent memory, a random-access memory (RAM) and/or a non-volatile memory in a computer-readable medium, such as a read-only memory (ROM) or a flash RAM; the memory comprising at least one memory chip.

The embodiments of the present invention provide a storage medium having a program stored thereon. When the program is executed by a processor, the method for processing digital asset based on blockchain is implemented.

The embodiments of the present invention provide a processor, which is configured to run program, wherein when the program is running, the method for processing digital asset based on blockchain is executed.

The embodiments of the present invention provide a device, which comprises a processor, a memory and a program stored on the memory and runnable on the processor. When executing the program, the processor implements the following steps: acquiring target digital assets to be transferred into a primary account, wherein the primary account is an account created on the blockchain; and transferring the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account.

After transferring the target digital assets into the primary account, the method further comprises: transferring a first digital asset in the target digital assets from the primary account into a first sub-account through a first position in the blockchain, so that a first resource transfer event is performed by using the first digital asset in a first digital asset transfer object linked by the first sub-account, wherein the first sub-account is one of the multiple sub-accounts.

After transferring the target digital assets into the primary account, the method further comprises: transferring a first digital asset in the target digital assets from the primary account into a first sub-account through a first position in the blockchain, so that a first resource transfer event is performed by using the first digital asset in a first digital asset transfer object linked by the first sub-account, wherein the first sub-account is an account in the first digital asset transfer object linked by one of the multiple sub-accounts, and the first digital asset is configured to be transferred into the first sub-account during or after performing the first resource transfer event.

After transferring a first digital asset in the target digital assets from the primary account to a first sub-account in the multiple sub-accounts, the method further comprises: synchronizing the transfer information to positions other than the first position in the blockchain through the first position, so that the transfer information is recorded at positions other than the first position in the blockchain, wherein the transfer information at least comprises: the primary account and the first sub-account with the corresponding relationship, the remaining digital assets of the primary account after transferring the first digital asset out, and the digital assets of the first sub-account after transferring the first digital asset in.

Transferring a first digital asset in the target digital assets from the primary account into a first sub-account comprises through a first position in the blockchain: acquiring a smart contract of the primary account and a smart contract of the first sub-account; and transferring the first digital asset in the target digital assets from the primary account into the first sub-account according to the smart contract of the primary account and the smart contract of the first sub-account.

Before transferring the target digital assets into the primary account, the method further comprises: acquiring a transfer request for requesting to transfer the target digital assets, wherein the transfer request carries information about the target digital assets to be transferred and information about the primary account into which the target digital assets are to be transferred; and acquiring the target digital assets to be transferred into the primary account comprises: acquiring the target digital assets to be transferred into the primary account when the information about the primary account meets a transfer condition.

Acquiring the transfer request for requesting to transfer the target digital assets comprises: acquiring the transfer request generated in response to a touch operation on a target application or a target webpage.

Transferring the target digital assets into the primary account comprises: transferring the target digital assets into a resource storage device; and establishing a mapping relationship between the primary account and the target digital assets, wherein the resource storage device is in an offline state after storing the target digital assets.

The digital asset transfer object comprises: a target application or a target webpage.

Before acquiring target digital assets to be transferred into the primary account, the method further comprises: creating a primary account in the blockchain; calling a smart contract corresponding to a sub-account to be created under the primary account; and creating the multiple sub-accounts under the primary account on the basis of the smart contract corresponding to the sub-accounts to be created under the primary account.

After transferring the target digital assets into the primary account, the method further comprises: when it is detected that the primary account is disabled at a first position in the blockchain, synchronizing the disable information to positions other than the first position in the blockchain through the first position, so that the disabling information is recorded at positions other than the first position in the blockchain, wherein the disabling information comprises: disabling the primary account and multiple sub-accounts corresponding to the primary account. The device herein may be a server, a PC, a PAD, a mobile phone and so on.

The present application also provides a computer program product, which is suitable for executing a program initialized with the following method steps when executed on a data processing device: acquiring target digital assets to be transferred into a primary account, wherein the primary account is an account created on the blockchain; and transferring the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account.

After transferring the target digital assets into the primary account, the method further comprises: transferring a first digital asset in the target digital assets from the primary account into a first sub-account through a first position in the blockchain, so that a first resource transfer event is performed by using the first digital asset in a first digital asset transfer object linked by the first sub-account, wherein the first sub-account is one of the multiple sub-accounts.

After transferring the target digital assets into the primary account, the method further comprises: transferring a first digital asset in the target digital assets from the primary account into a first sub-account through a first position in the blockchain, so that a first resource transfer event is performed by using the first digital asset in a first digital asset transfer object linked by the first sub-account, wherein the first sub-account is an account in the first digital asset transfer object linked by one of the multiple sub-accounts, and the first digital asset is configured to be transferred into the first sub-account during, or after performing the first resource transfer event.

After transferring a first digital asset in the target digital assets from the primary account to a first sub-account in the multiple sub-accounts, the method further comprises: synchronizing the transfer information to positions other than the first position in the blockchain through the first position, so that the transfer information is recorded at positions other than the first position in the blockchain, wherein the transfer information at least comprises: the primary account and the first sub-account with the corresponding relationship, the remaining digital assets of the primary account after transferring the first digital asset out, and the digital assets of the first sub-account after transferring the first digital asset in.

Transferring a first digital asset in the target digital assets from the primary account into a first sub-account comprises through a first position in the blockchain: acquiring a smart contract of the primary account and a smart contract of the first sub-account; and transferring the first digital asset in the target digital assets from the primary account into the first sub-account according to the smart contract of the primary account and the smart contract of the first sub-account.

Before transferring the target digital assets into the primary account, the method further comprises: acquiring a transfer request for requesting to transfer the target digital assets, wherein the transfer request carries information about the target digital assets to be transferred and information about the primary account into which the target digital assets are to be transferred; and acquiring the target digital assets to be transferred into the primary account comprises: acquiring the target digital assets to be transferred into the primary account when the information about the primary account satisfies a transfer condition.

Acquiring the transfer request for requesting to transfer the target digital assets comprises: acquiring the transfer request generated in response to a touch operation on a target application or a target webpage.

Transferring the target digital assets into the primary account comprises: transferring the target digital assets into a resource storage device; and establishing a mapping relationship between the primary account and the target digital assets, wherein the resource storage device is in an offline state after storing the target digital assets.

The digital asset transfer object comprises: a target application or a target webpage.

Before acquiring target digital assets to be transferred into the primary account, the method further comprises: creating a primary account in the blockchain; calling a smart contract corresponding to a sub-account to be created under the primary account; and creating the multiple sub-accounts under the primary account on the basis of the smart contract corresponding to the sub-accounts to be created under the primary account.

After transferring the target digital assets into the primary account, the method further comprises: when it is detected that the primary account is disabled at a first position in the blockchain, synchronizing the disable information to positions other than the first position in the blockchain through the first position, so that the disabling information is recorded at positions other than the first position in the blockchain, wherein the disabling information comprises: disabling the primary account and multiple sub-accounts corresponding to the primary account.

A person skilled in the art would understand that the embodiments of the present application may be provided as a method, a system or a computer program product. Thus, the present application can employ embodiment forms of complete hardware, complete software, or combining software and hardware aspects. Moreover, the present application can employ a form of computer program product implemented on one or more computer usable storage media (comprising, but not limited to, a disk memory, a CD-ROM, an optical memory and the like) containing computer usable program codes therein.

The present application is described with reference to flowcharts and/or block diagrams of the method, the device (system) and the computer program product according to the embodiments of the present application. It, should be understood that each flow and/or block in the flowcharts and/or the block diagrams and a combination of the flows and/or the blocks in the flowcharts and/or the block diagrams may be implemented by computer program instructions. These computer program instructions may be provided for a general computer, a dedicated computer, an embedded processor or processors of other programmable data processing devices to generate a machine, so that instructions executed by the computers or the processors of the other programmable data processing devices generate an apparatus for achieving functions designated in one or more flows of the flowcharts and/or one or more blocks of the block diagrams.

These computer program instructions may also be stored in a computer readable memory capable of guiding the computers or the other programmable data processing devices to work in a specific mode, so that the instructions stored in the computer readable memory generate a manufactured product comprising an instruction apparatus, and the instruction apparatus achieves the functions designated in one or more flows of the flowcharts and/or one or more blocks of the block diagrams.

These computer program instructions may also be loaded to the computers or the other programmable data processing devices, so that a series of operation steps are executed on the computers or the other programmable devices processing so as to generate processing implemented by the computers, and therefore the instructions executed on the computers or the other programmable devices provide steps of achieving the functions designated in one or more flows of the flowcharts and/or one or more blocks of the block diagrams.

In a typical configuration, a computing device comprises one or more central processing units (CPU), an input/output interface, a network interface, and a memory.

The memory may comprise forms such as a non-permanent memory, a random access memory (RAM) and/or a non-volatile memory in a computer-readable medium, such as a read-only memory (ROM) or a flash RAM. The memory is an example of the computer-readable medium.

The computer-readable medium comprises permanent and non-permanent media, and removable and non-removable media, which may store information by any method or technique. The information may be a computer-readable instruction, a data structure, a program module or other data. The example of the computer storage medium comprises, but is not limited to, a phase change memory (PRAM), a static random-access memory (SRAM), a dynamic random-access memory (DRAM), other types of random-access memory (RAM), a read-only memory (ROM), an Electrically Erasable Programmable read-only memory (EEPROM), a flash memory or other memory techniques, a compact disc read-only memory (CD-ROM), a digital versatile disk (DVD) or other optical memories, or a magnetic cassette tape, a magnetic tape disk storage, or other magnetic storage devices or any other non-transmission media, which can be used for storing information accessible by the computing device. According to the definition herein, the computer-readable medium does not comprise computer-readable transitory media such as modulated data signals and carriers.

It should also be noted that terms “comprise”, “contain” or any other variations thereof are intended to cover a non-exclusive inclusion, so that a process, method, article or device comprising a series of elements not only comprises those elements, but also comprises those elements not explicitly listed, or comprises elements inherent to such a process, method, article or device. Under the situation of no more limitations, elements defined by the sentence “comprising a . . . ” do not exclude that additional identical elements exist in the process, method, article or device comprising those elements.

A person skilled in the art should understand that the embodiments of the present application may be provided as a method, a system or a computer program product. Thus, the present application can employ embodiment forms of complete hardware, complete software, or combining software and hardware aspects. Moreover, the present application can employ a form of computer program product implemented on one or more computer usable storage media (comprising, but not limited to, a disk memory, a CD-ROM, an optical memory and the like) containing computer usable program codes therein.

The above contents are only embodiments of the present application, and are not intended to limit the present application. As for a person skilled in the art, the present application may have various modifications and changes. Any modifications, equivalent replacements, improvements and the like made within the spirit and principle of the present application shall fall within the scope of claims of the present application.

What is claimed is:

1. A method for processing digital asset based on blockchain, comprising:
acquiring target digital assets to be transferred into a primary account, wherein the primary account is an account created on the blockchain; and
transferring the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account.

2. The method as claimed in claim 1, wherein, after transferring the target digital assets into the primary account, the method further comprises:
transferring, by a first position in the blockchain, a first digital asset in the target digital assets from the primary account into a first sub-account, so that a first resource transfer event is performed by using the first digital asset in a first digital asset transfer object linked by the first sub-account, wherein the first sub-account is one of the multiple sub-accounts.

3. The method as claimed in claim 1, wherein, after transferring the target digital assets into the primary account, the method further comprises:
transferring, by a first position in the blockchain, a first digital asset in the target digital assets from the primary account into a first sub-account, so that a first resource transfer event is performed by using the first digital asset in a first digital asset transfer object linked by the first sub-account, wherein the first sub-account is an account in the first digital asset transfer object linked by one of the multiple sub-accounts, and the first digital asset is configured to be transferred into the first sub-account during or after performing the first resource transfer event.

4. The method as claimed in claim 2 wherein, after transferring a first digital asset in the target digital assets from the primary account into a first sub-account in the multiple sub-accounts, the method further comprises:
synchronizing, by the first position, the transfer information to positions other than the first position in the blockchain, so that the transfer information is recorded at positions other than the first position in the blockchain, wherein the transfer information at least comprises: the primary account and the first sub-account with the corresponding relationship, the remaining digital assets of the primary account after transferring the first digital asset out, and the digital assets of the first sub-account after transferring the first digital asset in.

5. The method as claimed in claim 3, wherein, after transferring a first digital asset in the target digital assets from the primary account into a first sub-account in the multiple sub-accounts, the method further comprises:
synchronizing, by the first position, the transfer information to positions other than the first position in the blockchain, so that the transfer information is recorded at positions other than the first position in the blockchain, wherein the transfer information at least comprises: the primary account and the first sub-account with the corresponding relationship, the remaining digital assets of the primary account after transferring the first digital asset out, and the digital assets of the first sub-account after transferring the first digital asset in.

6. The method as claimed in claim 2, wherein, transferring, by a first position in the blockchain, a first digital asset in the target digital assets from the primary account into a first sub-account comprises:
acquiring a smart contract of the primary account and a smart contract of the first sub-account; and
transferring the first digital asset in the target digital assets from the primary account to the first sub-account according to the smart contract of the primary account and the smart contract of the first sub-account.

7. The method as claimed in claim 1, wherein, before transferring the target digital assets into the primary account, the method further comprises:
acquiring a transfer request for requesting to transfer the target digital assets, wherein the transfer request carries information about the target digital assets to be transferred and information about the primary account into which the target digital assets are to be transferred; and
acquiring the target digital assets to be transferred into the primary account comprises: acquiring the target digital assets to be transferred into the primary account when the information about the primary account satisfies a transfer condition.

8. The method as claimed in claim 7, wherein acquiring the transfer request for requesting to transfer the target digital assets comprises:
acquiring the transfer request generated in response to a touch operation on a target application or a target webpage.

9. The method as claimed in claim 1, wherein transferring the target digital assets into the primary account comprises:
transferring the target digital assets into a resource storage device, and establishing a mapping relationship between the primary account and the target digital assets, wherein the resource storage device is in an offline state after storing the target digital assets.

10. The method as claimed in claim 1, wherein the digital asset transfer object comprises: a target application or a target webpage.

11. The method as claimed in claim 1, wherein, before acquiring target digital assets to be transferred into the primary account, the method further comprises:
creating a primary account in the blockchain;
calling a smart contract corresponding to a sub-account to be created under the primary account; and
creating the multiple sub-accounts under the primary account on the basis of the smart contract corresponding to the sub-accounts to be created under the primary account.

12. The method as claimed in claim 1, wherein, after transferring the target digital assets into the primary account, the method further comprises:
when it is detected that the primary account is disabled at a first position in the blockchain,
synchronizing, by the first position, disabling information to positions other than the first position in the blockchain, so that the disabling information is recorded at positions other than the first position in the blockchain, wherein the disabling information comprises: disabling the primary account and multiple sub-accounts corresponding to the primary account.

13. An apparatus for processing digital asset based on blockchain, comprising:
an acquisition unit, configured to acquire target digital assets to be transferred into a primary account, wherein the primary account is an account created on the blockchain; and
a transfer-in unit, configured to transfer the target digital assets into the primary account, wherein the primary account corresponds to multiple sub-accounts, each sub-account links to a digital asset transfer object, and the target digital assets transferred into the primary account is configured to be allowed to be transferred between the primary account and an account in the digital asset transfer object linked to at least one sub-account.

14. The apparatus as claimed in claim 13, wherein, the apparatus further comprising:
a first transfer unit, configured to transfer, after transferring the target digital assets into the primary account, by a first position in the blockchain, a first digital asset in the target digital assets from the primary account into a first sub-account, so that a first resource transfer event is performed by using the first digital asset in a first digital asset transfer object linked by the first sub-account, wherein the first sub-account is one of the multiple sub-accounts.

15. The apparatus as claimed in claim 13, wherein, the apparatus further comprising:
a first transfer unit, configured to transfer, after transferring the target digital assets into the primary account, by a first position in the blockchain, a first digital asset in the target digital assets from the primary account into a first sub-account, so that a first resource transfer event is performed by using the first digital asset in a first digital asset transfer object linked by the first sub-account, wherein the first sub-account is an account in the first digital asset transfer object linked by one of the multiple sub-accounts, and the first digital asset is configured to be transferred into the first sub-account during or after performing the first resource transfer event.

16. The apparatus as claimed in claim 14, wherein, the apparatus further comprising:
a first synchronizing unit, configured to synchronize, after transferring a first digital asset in the target digital assets from the primary account into a first sub-account in the multiple sub-accounts, by the first position, the transfer information to positions other than the first position in the blockchain, so that the transfer information is recorded at positions other than the first position in the blockchain, wherein the transfer information at least comprises: the primary account and the first sub-account with the corresponding relationship, the remaining digital assets of the primary account after transferring the first digital asset out, and the digital assets of the first sub-account after transferring the first digital asset in.

17. The apparatus as claimed in claim 15, wherein, the apparatus further comprising:
a second synchronizing unit, configured to synchronize, after transferring a first digital asset in the target digital assets from the primary account into a first sub-account in the multiple sub-accounts, by the first position, the transfer information to positions other than the first position in the blockchain, so that the transfer information is recorded at positions other than the first position in the blockchain, wherein the transfer information at least comprises: the primary account and the first sub-account with the corresponding relationship, the remaining digital assets of the primary account after transferring the first digital asset out, and the digital assets of the first sub-account after transferring the first digital asset in.

18. The apparatus as claimed in claim 14, wherein, the first transfer unit comprises:
a first acquisition module, configured to acquire smart contract of the primary account and a smart contract of the first sub-account; and
a transfer module, configured to transfer the first digital asset in the target digital assets from the primary account to the first sub-account according to the smart contract of the primary account and the smart contract of the first sub-account.

19. A storage medium, comprising a program stored in the storage medium, wherein the program executes the method for processing digital asset based on blockchain as claimed in claim 1.

20. A processor, which is configured to run a program, wherein the program is run to execute the method for processing digital asset based on blockchain as claimed in claim 1.
